(19) United States
(12) Patent Application Publication
(10) Pub. No.: US 2022/0053014 A1
(43) Pub. Date: Feb. 17, 2022

(54) System and method for clustering security-related information

(71) Applicant: Infobyte LLC, Miami, FL (US)

(72) Inventors: Yihua Zhong, Berkeley, CA (US); Federico Kirschbaum, Buenos Aires (AR)

(21) Appl. No.: 17/402,521

(22) Filed: Aug. 14, 2021

Related U.S. Application Data
(60) Provisional application No. 63/065,581, filed on Aug. 14, 2020.

(51) Int. Cl. H04L 29/06; G06F 16/22

(52) U.S. Cl. CPC H04L 63/1433; G06F 16/221

(57) ABSTRACT

A system and method clusters security-related information in a network having a target system with at least one target host. A security-analysis tool is in communication with the network. A security workspace having a data store is in communication with the network. A data intake and integration module receives security information from the security analysis tool into the security workspace and enters the security information into first and second columns of a table in the data store. A weight assignment module adds a third column to the table. A partitioning module determines a smallest-cost partition of a bipartite graph represented by the table, and an electronic display displays the smallest-cost partition.

### CROSS-REFERENCE TO RELATED APPLICATIONS

This application claims the benefit of U.S. Provisional Patent Application Ser. No. 63/065,581, filed Aug. 14, 2020, entitled “System and method for clustering security-related information,” which is incorporated by reference herein in its entirety.

### FIELD OF THE INVENTION

The present invention relates generally to a system and method for ordering the information generated during a penetration test.

### BACKGROUND OF THE INVENTION

Ensuring that a network of computer security systems is secure has been a problem since the inception of computers (see, e.g., [“Multics Security Evaluation: Vulnerability Analysis,” by Paul A. Karger, 2Lt, USAF Roger R. Schell, Maj, USAF. 1974]). Security audits or analysis or assessments come in various forms. For example, penetration tests, which are a form of security assessment where a target system (or a subset of the said system) is attacked in order to uncover threats which impose risk on the business or purpose of the system, and vulnerability scans, which are tests specific to uncover (software) vulnerabilities in the target systems. Security audits are performed to uncover threats to the confidentiality, integrity, or availability of a system, the information it manages, or the services it renders. Moreover, the security team of an organization may perform infrastructure inventories or other tasks, which aid their assessments and have to do with recollecting information that describes their network and its functioning.

Typically, during a security analysis, a team of security professionals (“security analysts,” or “penetration testers”) attempts to uncover security threats faced by a collection of target systems and to document findings for use in managing the underlying risk. The security analysis starts either with no information or with some information, e.g., collected in a previous analysis or via an external procedure. This information may be inexact (say, as it is outdated) and IP addresses or other parameters might have changed. The target systems may belong to, for example, a business, a home user, office, and/or any other entity which will hereafter be referred as an “organization.” The security analysts strategically execute tasks and actions to uncover threats or indications of possible threats. The tasks and actions are generally executed with the aid of computer software and systems.

A security analysis is often based on a scope that is typically drawn from a document specification. The scope narrows the systems to be tested (e.g., a list of Internet Protocol (IP) addresses, networks, labels or other means to univocally identify the target set), threats to test, and other details. The scope may include, for example a list of (internet-facing) IP addresses to be targeted, URIs, domains or subdomains, specific threats to be tested, network equipment, or any other computer system that is part of the target organization. The scope also defines the amount of resources to be directed to the test, and in particular, the size of the team performing the test (if it is manual) and the time window when test is to be performed.

Performing a security analysis is not an easy task. The security team typically has a limited time to perform the test, and a limited personnel that define the scope of the analysis. The scope of a test will define, for example, computer hosts of interest and may also define restrictions, including some hosts that are untouchable. The security analysis needs to uncover higher risk threats that, when present, fall in the scope with a limited amount of resources, which force the tester to carefully select which actions to execute. Moreover, the tester(s) need to be careful not to modify the system, for example, by deleting or modifying business-critical data or causing a denial of service. This is especially true in a penetration test.

In a security analysis, actions are performed and the results recorded. An action or probe may involve, for example, attempting to connect to a service in a remote system and recording the output (if any), or connecting to an open service (for example, an HTTP service) in one of the target computers and sending specifically-crafted data, or sending an email as part of a phishing attack, or any other penetration testing action known to persons having skill in the art. In many cases, penetration testing amounts to using a special-purpose tool to uncover vulnerabilities or information that leads to discovering vulnerabilities.

The penetration test (and more generally, the security analysis) tools include programs which may run in a standard computer system, or as embedded software in another computing device. Each security analysis action and its response, generates information which builds the security analyst's knowledge of the target system. However, the size and complexity of this information may increase rapidly with each action.

The judgment of individuals performing the penetration test and analyzing the resulting data, or even the tools that consume this information, may change depending on how this data is presented.

During a security analysis, one may use automated or semi-automated tools, including but not limited to vulnerability scanners to uncover vulnerabilities in the components of a system (e.g., a network). In a vulnerability scan, several tests are incorporated into the software and firmware running in target systems in order to gather evidence of vulnerabilities. In contrast with a penetration test where a vulnerability is confirmed by a specific test which exploits this vulnerability, in a vulnerability scan the evidence may lead to a false positive (meaning that the evidence was misleading, and no vulnerability was present). With the vulnerability scan report (which is the result of a vulnerability scan), an experienced security professional may deduce threats and estimate the system's risk. The results from these tools improve when provided with information about the target system (network).

Therefore, there is a need to present security-related information in a way that allows consumers (pentesters, security analysts and other IT professionals) to have a better understanding of the security stance, and more importantly, allow them to uncover higher-risk security threats and other valuable security information.

### SUMMARY OF THE INVENTION

Embodiments of the present invention provide a system and method for clustering security-related information. Briefly described, the present invention is directed to a system and method for clustering security-related information in a network having a target system with at least one target host. A security-analysis tool is in communication with the network. A security workspace having a data store is in communication with the network. A data intake and integration module receives security information from the security analysis tool into the security workspace and enters the security information into first and second columns of a table in the data store. A weight assignment module adds a third column to the table. A partitioning module determines a smallest-cost partition of a bipartite graph represented by the table, and an electronic display displays the smallest-cost partition.

Exemplary embodiments of the present invention provide a system and method of clustering of security-related information in a computer network. In a network of computers, the clustering method includes security-analysis applications, at least one security workspace receiving information from the applications, at least one target host that is part of the network of computers, and a distance function for bipartite graphs.

The method includes the steps of receiving one piece of data, the data including at least a host label and a second label associated to this host; and creating a partition of the data, by associating the data with a weighted bipartite graph and finding a partition that minimizes the cost over all the partitions.

It is a further object of the present invention to cluster security related information according to pairs of a host IP address and a port number. It is yet other object of the invention to produce a tree of partitions is stored, where each level of the tree underlies a partition of the security related information, and where going from one level to the next involves partitioning one of the objects of the lower level.

Hence, the partitioning process may continue until a level where each partition has exactly one item, or may be stopped when a “stop condition” is established. It is an object of this invention to have a stop condition established by one of the following criteria: computing the number of hosts in each partition and establishing a stop if the number is below the predetermined value, or establishing a stop if the number of clusters is bigger than the predetermined value.

It is yet another object of the present invention, to establish the stop condition when either of: each item in the tree has exactly N hosts or less; or the size of the bipartite graph, computed as the sum of weights for all of its edges does not exceed the constant N, wherein N is a predefined constant.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a schematic diagram depicting an exemplary network with eight target hosts and three testing hosts.

FIG. 2 is a flowchart of an exemplary method embodiment.

FIG. 3 is a schematic diagram of is a tree of depth one under the first embodiment.

FIG. 4 is a schematic diagram of is a tree of depth two under the first embodiment.

FIG. 5 is a schematic system block diagram of a first embodiment of the present invention.

FIG. 6 is a schematic diagram illustrating an example of a system for executing functionality of the present invention.

FIG. 7 is a schematic diagram illustrating different host groupings.

FIG. 8 is a schematic block diagram of a second system embodiment for implementing the method of FIG. 2.

### DETAILED DESCRIPTION

The following definitions are useful for interpreting terms applied to features of the embodiments disclosed herein, and are meant only to define elements within the disclosure.

As used within this disclosure, a “partition” of a set refers to two or more subsets with no pair-wise intersection, such that the union of all of these sets is equal to the original set. This is a standard term known in set theory, mathematics, and computer science.

As used within this disclosure, a “(partition) cost function” for a weighted bipartite graph refers to a function that assigns values (say real numbers) to each partition of a weighted bipartite graph.

As used within this disclosure, generally in computer security, and in particular in vulnerability scans and penetration tests, networked computing devices are called “host.” In general, a host is a computer device with a network connection, including but not limited to a network interface, or a BlueTooth interface, among others. A host, for example through a network interface or any other interface, can expose one or more services. Examples of services include but are not limited to an SSH server, a web server, a printer server, an FTP server. Network services are often exposed in port numbers that are well known, e.g., port 22 is for SSH, 21 for FTP and 80 and 443 for web.

Services are implemented by software and protocols which may include vulnerabilities. As used within this disclosure, a “vulnerability” generally refers to a point of entry to the target system that may be exploited by an unauthorized entity (or “attacker”). Vulnerabilities may be labeled in different ways, which include but are not restricted to the tool or module by which it was found, a CVE number associated to the vulnerability, or a name defined by the penetration tester or the team that develops this tool. Formally, the vulnerability may be associated to the service, or directly to the host exposing the service.

As used within this disclosure, a “CVE” stands for Common Vulnerabilities and Exposures, and generally refers to a database which includes a broad range of publicly-known vulnerabilities.

As used within this disclosure, “exposing a service” refers to a (distributed) application that as part of the client-server model provides a resource or service to requesters (clients).

As used within this disclosure, a “banner” refers to a string that advertises a service and some additional information, which may include an implementation vendor, a version, or configuration parameters.

As used within this disclosure, “pentest” is shorthand for penetration test, which may refer to a an authorized simulated cyberattack on a target system. Likewise, a “pentester” is used as shorthand for a penetration tester, where a penetration tester is an individual testing the security of a target system.

As used within this disclosure, “clustering” refers to the task of grouping a set of objects in such a way that objects in the same group (called a cluster) are more similar (in some sense) to each other than to those in other groups (clusters).

Reference will now be made in detail to embodiments of the present invention, examples of which are illustrated in the accompanying drawings. Wherever possible, the same reference numbers are used in the drawings and the description to refer to the same or like parts.

Exemplary embodiments of the present invention provide a system and method of clustering of security-related information in a computer network.

A security analysis of a target system may start with no information or with some information, for example, information collected in a previous analysis or by an external procedure. This information may be inexact, for example, if the information is incomplete, is outdated and/or the IP addresses or other parameters of the target system have changed.

A security analyst typically discovers hosts and information pertaining to these hosts by using of security and network tools. A tool (used during a penetration test, vulnerability scan, or other action that results in security-related information) may, for example, communicate with a service of the target system, and query or make a request emulating a software client, to a port number that implements a service. The service may answer with a response, for example, a response through the same communication channel (or a new one) and will often include one or more banners. Furthermore, sometimes the pentester (or a tool he uses) may glean out information through a covert channel, e.g., the time it takes for the service to send the response, the temperature change in the physical system (or subsystem) that runs the service, the acoustic emanations of this system, or the size (e.g., in bytes) of the response. Moreover, a security analyst may perform phishing campaigns in order to test how well is the target organization prepared to real phishing attacks. This is done by sending emails to the target the organization's users with the aid of special-purpose tools and registering results (opened emails, email address, host IP address, was the attack successful, etc.). These results are also security-relevant information.

Services are implemented by software and protocols which may include vulnerabilities. And it often falls within the security test scope to discover vulnerabilities on these hosts and services. Vulnerabilities may be labeled by different means, which include but are not restricted to the tool or module by which it was found, a CVE number associated to the vulnerability, or a name defined by the penetration tester or the team that develops this tool. Formally, the vulnerability may be associated to the service, or directly to the host exposing the service.

For the embodiments described herein, the target system(s), generally have a specific purpose, for example, an etailer selling books online, a bank, or an application forecasting the weather, among others. The security analyst assesses the security of the target system, where the security analyst may be one or a team of security professionals leading. For the sake of simplicity, the embodiments refer to a security analyst who performs a security test against a system, allowing for the aforementioned variations. Allowing again for the aforementioned variations, according to the embodiments the tests may be run from a set of testing hosts.

In a computer security analysis, a security analyst targets a set of hosts and other information systems which may be part of a private network, be networked to the Internet, or even be part of disjoint networks. A computer security analysis includes but is not limited to a penetration test or a vulnerability scan.

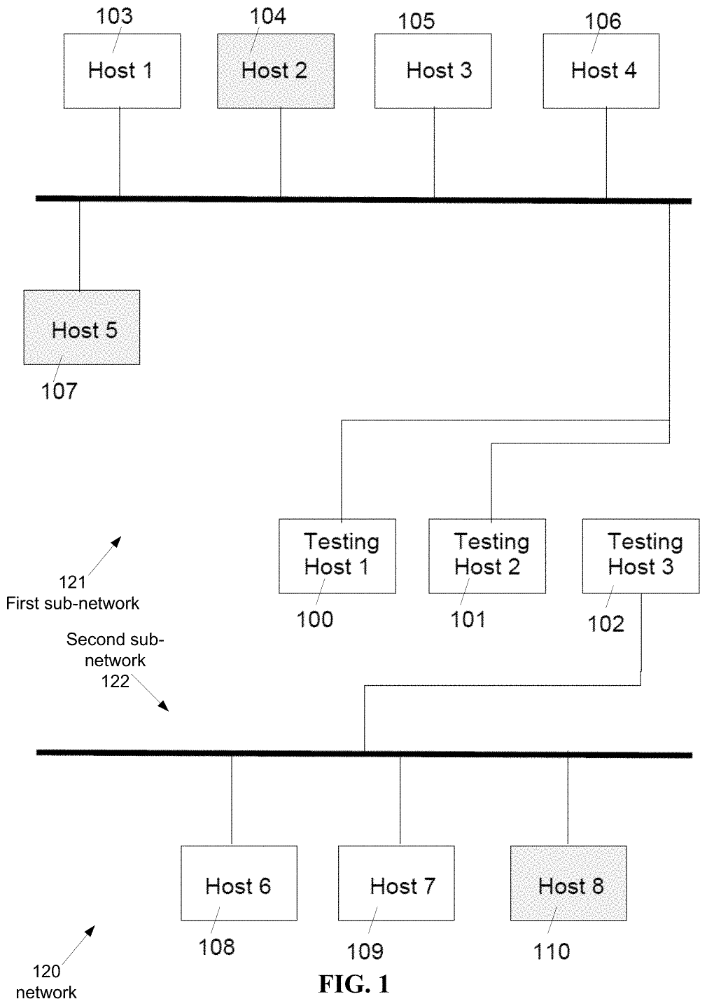

Networked computing devices are referred to herein as hosts. As shown in FIG. 1, in a preferred embodiment of the present invention, a security analyst operates a plurality of testing hosts 100, 101, 102 connected to an exemplary target network 120 (or target system). The exemplary network 120 also includes target hosts 103-110. The exemplary target network 120 includes eight target hosts and three testing hosts. As shown in FIG. 1, hosts 103 to 110 are each in one of in two different sub-networks 121, 122. While FIG. 1 shows two sub-networks 121, 122, in alternative embodiments the target network 120 may have one or more subnetworks and include any number of hosts. In this case, the security analysts control the testing hosts and need to analyze the security of the target hosts and the network 120.

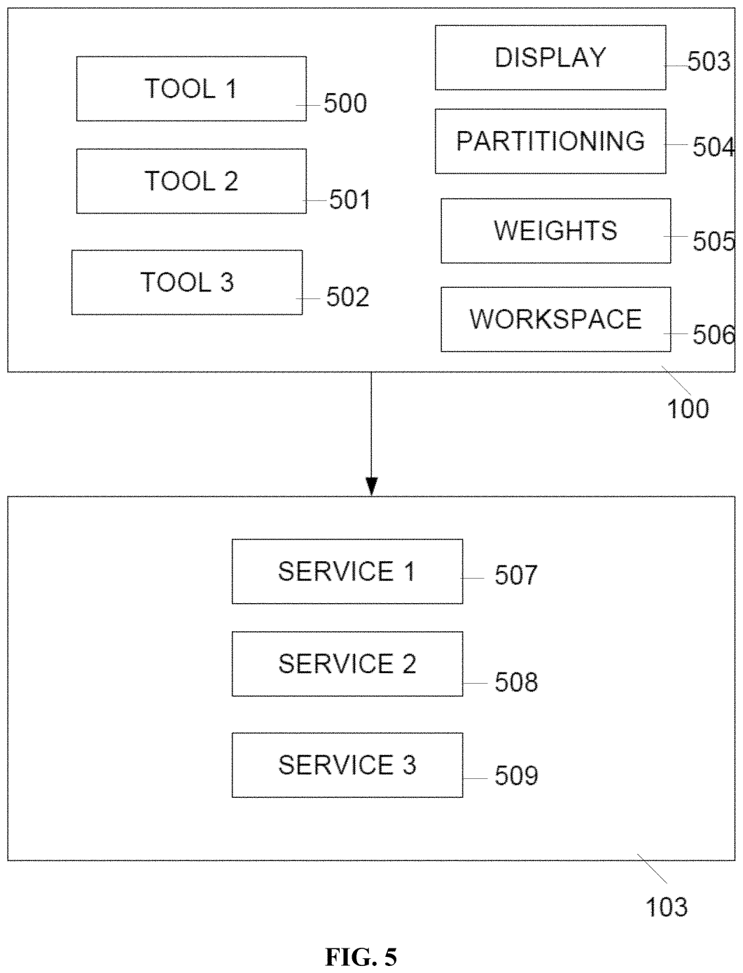

In the network 120, a security analyst uses a first tool 500 (FIG. 5) of a testing host 100 to probe at least one target host 103 in the network 120. The tool 500 (FIG. 5) may be automated or may require the security analyst to input parameters. As a result of the probe, the tool 500 (FIG. 5) communicates with a service 507 (FIG. 5) exposed by the target host and queries, or emulates a software client to make a request to a port number that implements the service 507 (FIG. 5). The service 507 (FIG. 5) may answer with a response. This response may be through the same communication channel as the query (or a new one) and will often include one or more “banners”; a banner being a string that advertises the service and some additional information, which may include an implementation vendor, a version, or even configuration parameters.

In some cases, the security analyst or a tool used by the security analyst may infer information indirectly and/or through a covert channel, for example, by measuring the time it takes for the service to send the response, measuring the temperature change in the physical system (or subsystem) that runs the service, sensing the acoustic emanations of this system, or determining the size (e.g., in bytes) of the response. This information may be consolidated in the tool, or in some other media, for example, in an external data store.

Security and network tools include but are not limited to nmap, Wireshark, Metasploit, Aircrack, Snort, Burp, Nikto, Nessus, Acunetix, Core Impact, Kali Linux, Canvas, Retina, Nagios. The security analyst may also obtain information through other means, including but not limiting to, receiving a file with this information (e.g., via email), or using an open-source intelligence (osint) tool, the security analyst may make a phone call and obtain for electronic transcription, or by directly obtaining information at a physical location to find wi-fi access points or any kind of information.

As part of the security analysis, the security analyst may perform other actions after using the first, second, or third tool. As used within the invention, the inclusion of three tools is arbitrary and any number of tools is possible. These actions may be executed sequentially, in parallel and in various orders. Each of these actions may include the use of a tool to uncover security-related information. Eventually, the security analyst may stop or pause carrying out actions.

In the preferred embodiment of the present invention, the present system and method collects the security information. That is, the system interacts with these tools, or their storage, in order to retrieve and possibly process the information these tools obtained. The system is prepared to collect information from a predefined set of tools. New tools may be added through an API (application programming interface) that has been built-in specifically for this purpose (as it is known in the art). The collected information is stored in one or more tables within a database which is part of the security workspace described below. Alternative other data structures and storage media may be used.

The information collected may include a set of hosts, a set of services exposed by these hosts, vulnerabilities present in these services, tags to any of the above that are either manually written by the security analyst or computed automatically by a tool. Hosts may be labeled by internet protocol (IP) addresses, and services by one of a port number, a banner, a portion or transformation of the banners received from this service, and/or even a tag.

Examples of tags include but are not limited to a media access control (MAC) address, an operating system (OS) name, a service name, the time the information is created (e.g., the time when a host is discovered), or when the information was last updated. Hence, the tables within the database may include at least one entry per host, the entry including columns describing information about the host. The labeling process returning information by the tools is transcribed into storage and can be defined arbitrarily, for example, following the rules described above or new rules, as long as they can be applied programmatically.

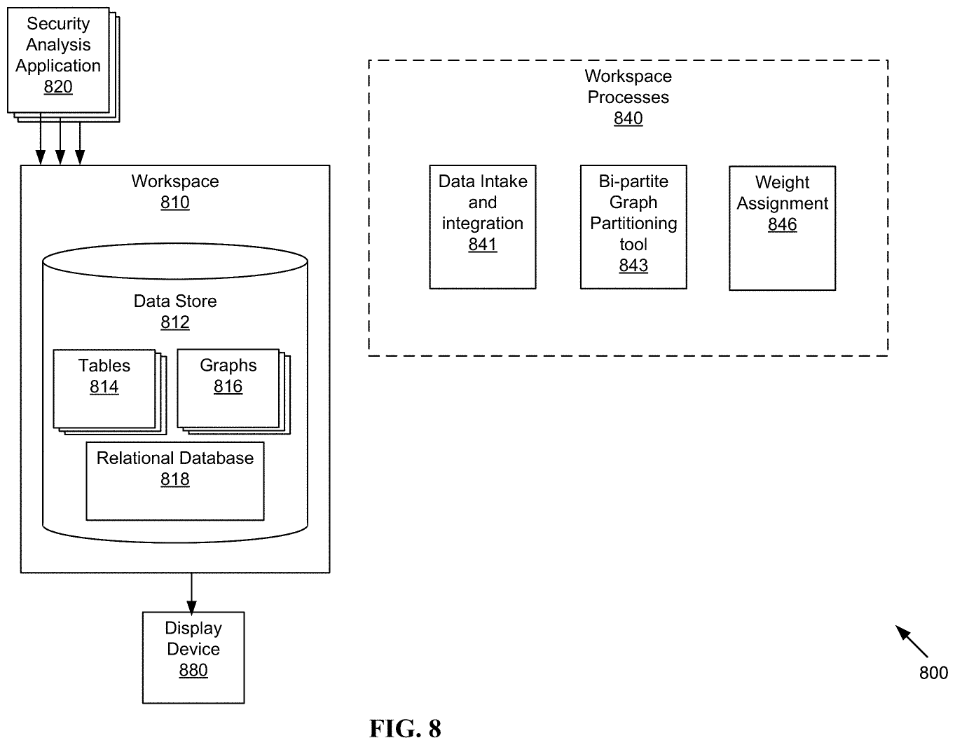

Regardless of how (security-related) information for the target network is obtained or is encoded, the application or object that processes and stores the information is referred to herein as the security workspace, or more simply, the workspace 810 (FIG. 8). In a preferred embodiment the workspace includes a relational database 880 (FIG. 8) which stores information received from all the tools (e.g., at least one table per tool). The workspace 810 (FIG. 8) typically includes the procedures which connect with these tools in order to retrieve the information (be it through push, pull or other methods), process this information and insert it into these tables. The workspace further includes the procedures 840 (FIG. 8) which, according to configuration, perform the information ordering step described below. In alternative embodiments, the information received from the tools may be stored in another storage form; and the same applies to the information-ordering byproduct.

At any given point of the security analysis the security analyst may call for an information ordering step. Alternatively, this call may be made automatically every time new information is entered to the workspace. One way to order workspace information is by grouping together like hosts and services with the underlying assumption that like services tend to include similar security risks.

In the preferred embodiment, the security-related information from a workspace is encoded as a two-column table where a first column represents host (labels), and a second column represents service (labels). A row represents a pair of host label and service label present in the workspace.

In alternative embodiments, the two sets may be: a) hosts and vulnerabilities associated to these hosts, b) hosts and tags, c) hosts and combinations of the above, or d) hosts and any other group of security-related information associated to these hosts. More specifically, the security-related information may include hosts and their vulnerabilities, for example, vulnerability scanner tools will produce this information; a workspace process will then take each pair of host and vulnerability produced by the vulnerability scanner tool and enter it as a row of the two column table—when criteria a) is selected. Generally speaking, the workspace, thus, includes logic for producing this table out of the information received. The security analyst may reconfigure and modify a predefined configuration, for example, that described by the preceding paragraph.

One such two-column table may be understood to represent a bipartite graph, where the two vertices sets are the different items in each column (the set of all the distinct items in the first column is associated to the first set of vertices and the set of all the distinct items in the second column is associated to the second set of graph vertices), and there is an edge between a left-column vertex and a right-column vertex if there is a row with both items in the table.

A third column representing weights (non-negative numbers) is added to the table, referred to herein as table T. As described further below, the three-column table may be associated with a bipartite weighted graph or weighted bipartite graph. The third column is computed by logic that is part of the present system and method (505). In the preferred embodiment, all weights are assigned the same value: 1 (number one). In alternative embodiments, the security analyst may manually input the weights , for example, by opening the table using table-manipulation software to enter the weights in a manner familiar to someone skilled in the art. Generally, any arbitrary assignment that assigns nonnegative values to the edges is allowed. For example, the user may arbitrarily prepare a priori a weight assignment for each service (or each possible value for the second column), so that, for example web services get weight 3, SSH gets weight 2 and ICMP gets weight 1; that is, the user prepares a map that for setting weights to any edge. Also, when the second set of vertices represents vulnerabilities, the Common Vulnerability Scoring System (or CVSS) of each vulnerability can be used as weight (see, e.g., en.wikipedia.org/wiki/Common_Vulnerability_Scoring_System). More generally, weights may be assigned by any function or algorithm that assigns nonnegative weights to all edges and receives as input the labels for the vertices joined by this edge. The present system and method includes logic (described below) to allow this computation; for example, a script in a computing language such as JavaScript allowing arithmetical computations.

Under the first embodiment, given the three-column table T representing a bipartite weighted graph G(H,S,W), a weighted bipartite graph partitioning tool 504 computes a partition H(H[0],S[0]). The process that computes a partition H(H[0],S[0]) returns two (three-column) tables T[0] and T[1] so that: a) all the rows in T[0] and T[1] are in T, b) no row from T is in both T[0] and T[1]. A description of this process and how it is adapt it the embodiment is provided below.

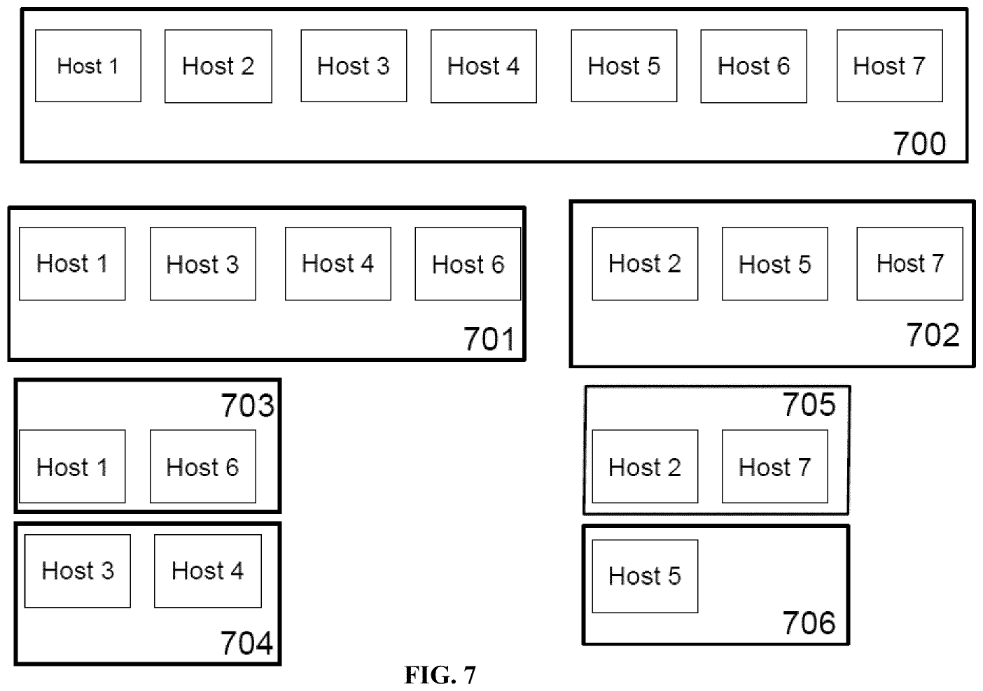

Once the partition II(H[0],S[0]) has been computed, the present system and method may present the results to the security analyst. Results may be displayed by an electronic display device, for example, a computer screen. Standard visualization metaphors which are known in the industry may apply. In the preferred embodiment of the present invention, the three tables are presented to the user (T, T[0] and T[1]). The system may further provide an option to view a graphical representation in which the hosts are displayed as boxes in two groups (see shaded hosts 104, 107, 110 in FIG. 1), one for each partition element, and each box includes a string of text (e.g., one of its labels). Alternatively, FIG. 7 depicts hosts 700 which are partitioned into hosts 701 and 702, each of which is partitioned into hosts 703 and 704, and 705 and 706 respectively. Moreover, when the pointing device of the user (mouse, trackpad, etc.,) hovers over the box more information may be displayed, including but not limiting to the set of all the labels which apply to this host.

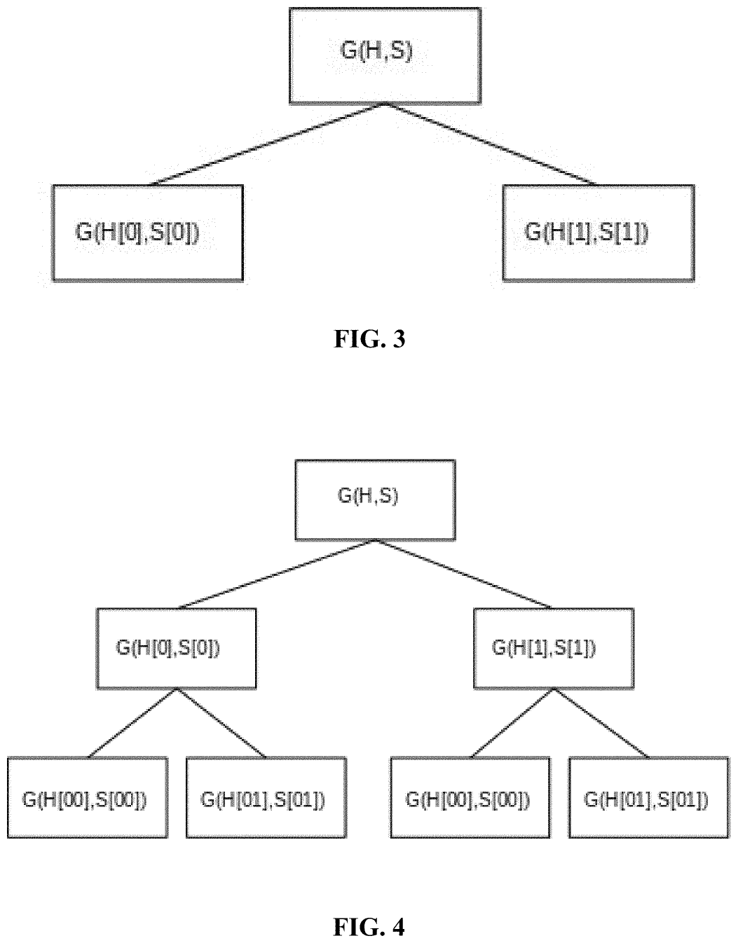

In another embodiment, the (partitioning) may continue as follows. Let H[1] denote H[O]^{c} and S[1] denote S[O]^{c}, the complements of H[0] in H and of S[0] in S respectively. This may be depicted as a tree of depth 1 (FIG. 3), where the root node G(H,S) has two children G(H[0],S[0]) and G(H[1],S[1]) who are the terminal leaves of this tree.

Consider the bipartite weighted graphs G(H[0],S[0]) and G(H[1],S[1]) where in each case only the weights w for edges in the graph are considered (and the other weights of W are removed). By calling the bipartite graph tool, partitions II(H[00],S[00]) of G(H[0],S[0]) and II(H[10],S[10]) of G(H[1],S[1]) may be obtained, or alternatively tables T[00] and T[01] that represent a partition of the graph underlying T[0], and tables T[10] and T[11] that represent a partition of the graph underlying T[1]. This may be depicted as a tree of depth 2 (FIG. 4), which consists in the tree where leave G(H[0],S[0]) has new children G(H[00],S[00]) and G(H[01],S[01]) that are the terminal leaves of this tree, and leaf G(H[1],S[1]) has new children G(H[10],S[10]) and G(H[11],S[11]), again terminal leaves.

The process may continue creating new partitions recursively until each terminal leave represents a graph with a single host. Alternatively, a condition may be selected to stop this recursion, a stop condition. The stop condition establishes may establish a complete stop on the partitioning process, or it may establish that a graph represented by a leaf in the above tree must no longer be partitioned, and hence the underlying branch stops to grow.

In a preferred embodiment of the present invention, a stop condition may be defined using the “size” of a graph G(A,B) given by the quantity W(A,B) defined above. For example, when this size drops below a given threshold, 10 for example, the condition is met, and this bipartite graph does not get partitioned. Other formulations of stop condition include but are not limited to:

A branch is no longer partitioned if percentage of hosts in that partition is smaller than a predetermined value. For example, if the percentage is 10% and the network includes 50 hosts, then any partition with 5 or less hosts in no longer split.

No further partitions are created if the number of graphs is bigger than a predetermined value.

According to a preferred embodiment of the present invention, the present system and methods takes a bipartite graph represented by table T, creates a partition into tables T[0] and T[1] as described above. Next the bipartite graph partitioning tool within the present system and method checks if the stop condition is met for the whole process or some of the branches. If a stop condition is not met for at least one of these, for example T[i] (where i is either 0 or 1), then the bipartite graph partitioning tool partitions the bipartite graph underlying T[i] into T[i0] and T[i1]. The bipartite graph partitioning tool continues partitioning each bipartite graph until the stop condition has been met for all of the terminal leaves in the tree.

FIG. 5 is a schematic diagram of a system embodiment of the present invention. For simplicity only one of the security analyst host 100 and one of the target hosts is depicted. Other hosts of the security analyst and target hosts may have the same or analogous components. Here, the host of the security analyst includes three exemplary tools 500, 501, 502. The security analyst commands the host, e.g., through a keyboard, mouse, touchpad or other. The security analyst may call one or more of the tools 500, 501 502 with input parameters. These tools 500, 501 502 probe any one of the services 507, 508, 509 running in the host 103. Every time these tools return with some output, the workspace subsystem 506 reads from the storage of these tools, processes this information, and produces rows that are included in the two-column table within the workspace storage. The security analyst may enter weights forming a third column in this table, or an automated process (possibly pre-configured) may enter the weights automatically, for example, via a weight subsystem 505. Once the three-column table has been formed, a partitioning tool 504 runs and produces a set of partitions as configured. As described earlier, the partitioning tool 504 may run once (producing two partitions), or may run iteratively producing more partitions. When the partitioning subsystem finishes, the display subsystem produces a visualization. This visualization may be displayed in the host's screen (see FIG. 1), or may be accessible via web remotely (see FIG. 7). A display subsystem 503 may store a form of the visualization in a web application which is accessible to authorized users, for example, using standard web application methodologies that are known in the art.

The embodiments described herein involve a bipartite graph mathematical object. A graph is a structure in which a set of objects are related; specifically, objects correspond to abstractions called vertices, and each of the related pairs of vertices is called an edge, i.e., a graph can be described by a set of objects V and a set of edges E, where an edge can be represented by a pair of vertices e=(v₁,v₂).

In “graph theory, a bipartite graph (or bigraph) is a graph whose vertices can be divided into two disjoint and independent sets U and V such that every edge connects a vertex in U to one in V.” Hence, the clustering problem may be solved by iteratively “breaking” the original bipartite graph G(H,S) and its sub-graphs, where each break is made minimizing the cost of the breaking, until a suitable clustering is reached. Both the steps for producing these breaks and assessing this suitability condition are described below.

A weighted bipartite graph G(H,S,W) is a bipartite graph G(H,S) where each edge is assigned a weight. Given an edge that joins vertices s and h, there is a weight w(s,h) in W associated to this edge. The weight is an arbitrary non-negative number. It is trivial then, to convert a weighted bipartite graph to a three-column table and viceversa, as described earlier.

Given a weighted graph G(V, E, W), the cut of V is defined by two non-intersecting subsets V₁ and V₂ of V (forming a partition of V). In computer science, one associates a number to this cut through a formula or algorithm. For example, cut(V₁, V₂) may be defined as the sum of all the weights between edges that have one vertex in V₁ and another vertex in V₂.

Following [“Bipartite Graph Partitioning and Data Clustering”, by Hongyuan Zha, Xiaofeng He, Chris Ding, Horst Simon, Ming Gu appearing in the “Proceedings of the tenth international conference on Information and knowledge management”; Atlanta, Ga., USA; pp 25-32 in 2001, which is incorporated by reference herein in its entirety], a possible cost function on partitions II(A,B) (for A subset of H and B subset of S) on G(H,S) is given by the cost function:

cut(A,B):=W(A,B^{c})+W(A^{c},B), (Eq. 1)

where W(A,B^{c}) is the sum of all the weights for edges between vertices in A and B^{c}, W(A^{c},B) is the sum of all the weights for edges between vertices in Ac and B, and more generally, for any subset X of H and Y of H, W(X,Y) is the sum of the weights for edges between vertices in X and Y. (This uses the notion of complement from set theory and given a subset A of a set H, denoted by A^{c} the complement of A in H.)

Another possible cost function, again following the above article (opus citato) for partitions of G(H,S) is given by the formula

Ncut(A,B):=(cut(A,B)/(W(A,S)+W(H,B)))+(cut(A_{c},B_{c})/(W(A_{c},S)+W(H,B_{c}))). (Eq. 2)

As understood by a person skilled in the art, this cost function may be replaced by another function, with modifications as dictated by the scenario. Other instantiations of cost functions are defined in the literature (see “Bipartite Graph Partitioning and Data Clustering,” by Hongyuan Zha, reference above). Under the first embodiment, the function Ncut( ) defined above is used.

In computer science terminology, a partition of a graph G(V,E) is given by two sub-graphs G(V₁, E₁), and G(V₂,E₂) where the vertices set V into two subsets V₁ and V₂ such that V=V₁ U V₂, V₁ and V₂ have empty intersection, and both E₁ and E₂ are subsets of E. Here, this partition is denoted as II(V₁,V₂) using the Greek capital letter “pi”.

The graph partitioning problem is defined as, given a weighted graph Graph(V,E,W) and a cost function cost(,) is finding a partition V₁ and V₂ of V such that any other subset V_{1′}, V_{2′} verifies cost(V₁, V₂)≤cost(V_{1′}, V_{2′}).

A cost function and a partitioning problem for a weighted bipartite graph G(H,S,W) can be defined, mutatis mutandis. For example, a cost function is defined over partitions (H₁,S₁) and (H₂,S₂) and cut((H₁,S₁),(H₂,S₂)) is written as the sum of all the weights for edges from vertices in (H₁,S₁) to vertices on (H₂,S₂). The partitioning problem is defined analogously. The literature includes several examples of partitioning algorithms for weighted bipartite graphs; see, for example, “Bipartite Graph Partitioning and Data Clustering,” by Hongyuan Zha, Xiaofeng He, Chris Ding, Horst Simon, Ming Gu. In “Proceedings of the tenth international conference on Information and knowledge management”, Atlanta, Ga., USA, pages 25-32, year 2001, ACM, and “Coclustering documents and words using Bipartite Spectral Graph Partitioning,” by Inderjit S. Dhillon, University of Texas Technical Report TR 2001-05, 2001, both of which are incorporated by reference herein in their entirety, and the references in these articles.

A bipartite graph partitioning tool is this a tool that solves the partitioning problem for a weighted bipartite graph as described above, i.e., and given the table T returns the tables T[0] and T[1]. One such partition may be obtained, for example, by a so-called brute-force search where the bipartite graph partitioning tool examines all the possible partitions (e.g., one at a time), computes the cost for each partition, and records only the one with the smallest cost. Given a bipartite graph having a finite number of nodes, there is a finite number of ways to partition the graph in two. For each partition, the cost is computed, and a partition such that all other partitions have the same or bigger cost is kept. When the cost function is the above “Ncut”, then the article of Zha et al. (opus citato) describes an efficient procedure for finding the smallest-cost partition, or if not the optimal (i.e., smallest) then a sub-optimal partition. (In computer science it may be the case that instead of looking for the best solution to a hard problem, an approximation, sub-optimal, or good-enough solution will suffice. This may be the case of the method of Zha et al.)

Generally speaking, a weighted bipartite graph partitioning procedure starts with an encoding of the graph and weights and computes the partition as two sets of graphs. For example, the weighted bipartite graph Graph(V,E,W) may be encoded as a three-columns table where one column represents a set of vertices, the second column represents the second set of vertices, and the third column represents the weight for the edges. So, a row (A,B,C) encodes the fact that vertex A from the first set is connected to vertex B from the second set by an edge with weight C. Another way of encoding this is by two numbered lists of labels (one for each vertex set) and a matrix (M[i,j])ᵢⱼ establishing the weights between vertex i and vertex j (see, e.g., [Zha, He et al., opus citato]). A weighted bipartite graph partitioning tool may execute the weighted bipartite graph partitioning procedure.

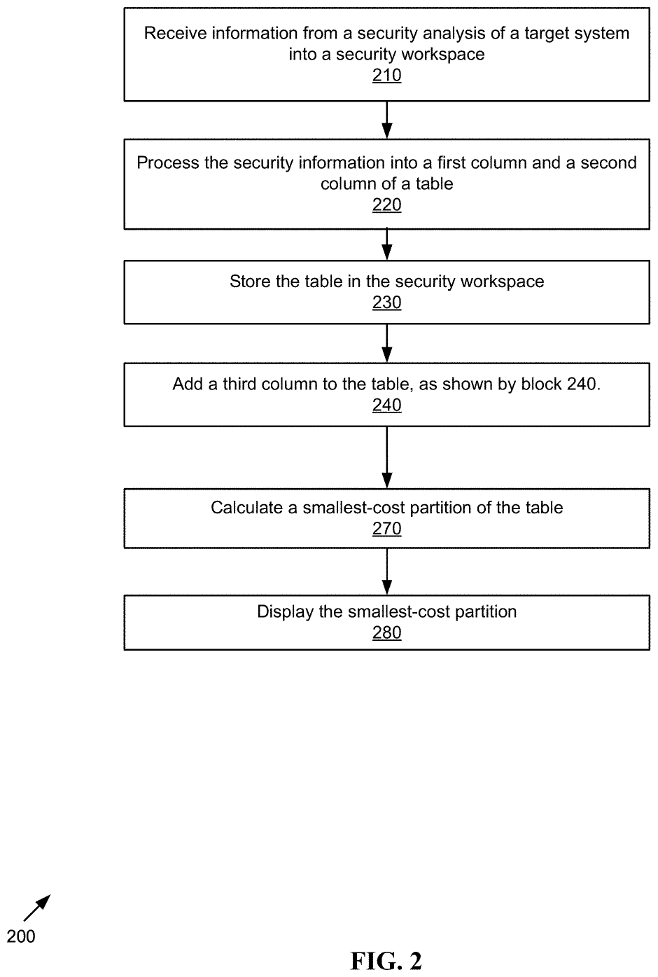

FIG. 2 is a flow chart of a first method embodiment of the present invention. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

Security information is received from a security analysis of a target system into a security workspace, as shown by block 210. The security information is processed into a first column and a second column of a table, as shown by block 220. The table is stored in the security workspace, as shown by block 230. A third column is added to the table, as shown by block 240, for example, a column of non-negative weights. A weighted bipartite graph is represented by the table T. A smallest-cost partition of the plurality of partitions is calculated, as shown by block 270. The smallest-cost partition is displayed, for example by an electronic display device, as shown by block 280.

FIG. 8 is a schematic block diagram of a second embodiment of a system 800 for implementing the method of FIG. 2. The system 800 clusters security-related information in a network 120 (FIG. 1) having a target system having at least one target host 101-107 (FIG. 1). A security-analysis application 820 in communication with the network 120 (FIG. 1) provides security information collected during a security analysis of the target system. A security workspace 810 is in communication with the network, 120 (FIG. 1). The security workspace may be hosted by one or more testing hosts 100-102 (FIG. 1) further comprising a data store, or externally, for example, by a server (not shown) in communication with the network 120 (FIG. 1).

A plurality of workspace modules 840 are used to process information in the workspace 810. Individual modules 840 may be resident within the workspace 810, and/or external to the workspace 810. The modules 840 may be one or more of several devices for providing functionality for the workspace 810, for example, hardware processors (FPGA, IC chips), software processes hosted by the workspace 810 or externally to the workspace. While there are three modules 841, 843, 846 in the system embodiment shown by FIG. 8, in alternative embodiments there may be fewer modules than three, or more modules than three.

A data intake and integration module 841 is configured to receive security information from the security analysis application into the data store. For example, the data intake and integration module 841 may receive initial security information from one or more security analysis application(s) 820 and store the security information in one or more tables 814 in the data store 812. Thereafter, the data and intake module may receive additional security information and update existing tables 814 and/or store the security information in newly created tables 814. A weight assignment module 846 is configured to add a third column to the table 814, for example, a non-negative number indicating an assigned weight, as described previously. A bipartite graph partitioning tool 843 is configured to determine a smallest-cost partition of the table. An electronic display device 880 is configured to display the smallest-cost partition.

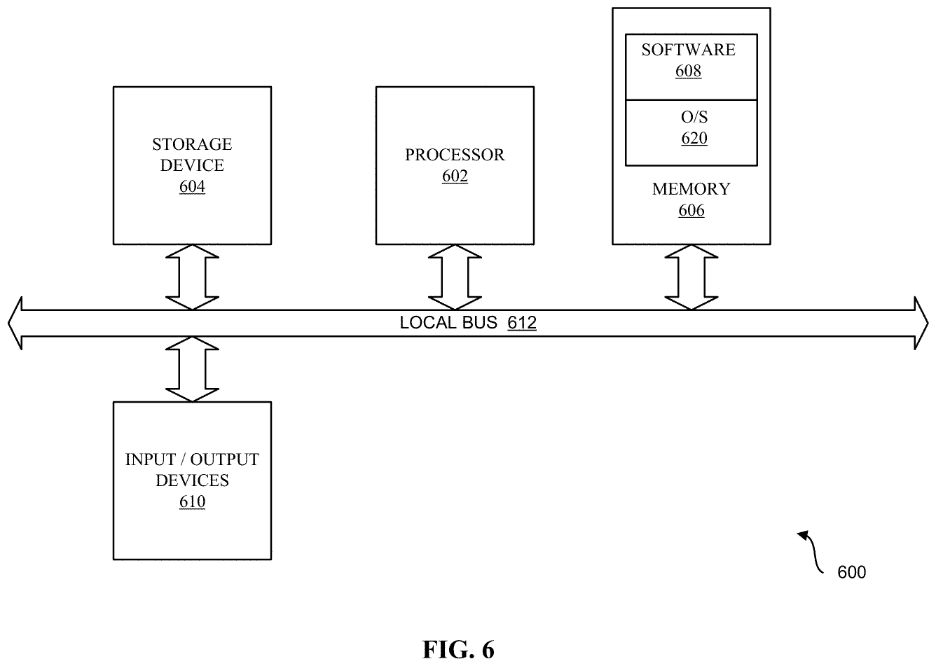

As previously mentioned, the present system for executing the functionality described in detail above may be a computer, an example of which is shown in the schematic diagram of FIG. 6. The system 600 contains a processor 602, a storage device 604, a memory 606 having software 608 stored therein that defines the above-mentioned functionality, input and output (I/O) devices 610 (or peripherals), and a local bus, or local interface 612 allowing for communication within the system 600. The local interface 612 can be, for example but not limited to, one or more buses or other wired or wireless connections, as is known in the art. The local interface 612 may have additional elements, which are omitted for simplicity, such as controllers, buffers (caches), drivers, repeaters, and receivers, to enable communications. Further, the local interface 612 may include address, control, and/or data connections to enable appropriate communications among the aforementioned components.

The processor 602 is a hardware device for executing software, particularly that stored in the memory 606. The processor 602 can be any custom made or commercially available single core or multi-core processor, a central processing unit (CPU), an auxiliary processor among several processors associated with the present system 600, a semiconductor based microprocessor (in the form of a microchip or chip set), a macroprocessor, or generally any device for executing software instructions.

The memory 606 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 606 may incorporate electronic, magnetic, optical, and/or other types of storage media. Note that the memory 606 can have a distributed architecture, where various components are situated remotely from one another, but can be accessed by the processor 602.

The software 608 defines functionality performed by the system 600, in accordance with the present invention. The software 608 in the memory 606 may include one or more separate programs, each of which contains an ordered listing of executable instructions for implementing logical functions of the system 600, as described below. The memory 606 may contain an operating system (O/S) 620. The operating system essentially controls the execution of programs within the system 600 and provides scheduling, input-output control, file and data management, memory management, and communication control and related services.

The I/O devices 610 may include input devices, for example but not limited to, a keyboard, mouse, scanner, microphone, etc. Furthermore, the I/O devices 610 may also include output devices, for example but not limited to, a printer, display, etc. Finally, the I/O devices 610 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 600 is in operation, the processor 602 is configured to execute the software 608 stored within the memory 606, to communicate data to and from the memory 606, and to generally control operations of the system 600 pursuant to the software 608, as explained above.

When the functionality of the system 600 is in operation, the processor 602 is configured to execute the software 608 stored within the memory 606, to communicate data to and from the memory 606, and to generally control operations of the system 600 pursuant to the software 608. The operating system 620 is read by the processor 602, perhaps buffered within the processor 602, and then executed.

When the system 600 is implemented in software 608, it should be noted that instructions for implementing the system 600 can be stored on any computer-readable medium for use by or in connection with any computer-related device, system, or method. Such a computer-readable medium may, in some embodiments, correspond to either or both the memory 606 or the storage device 604. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 602 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted, or otherwise processed in a suitable manner if necessary, and then stored in a computer memory.

In an alternative embodiment, where the system 600 is implemented in hardware, the system 600 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for clustering security-related information in a network comprising a target system comprising at least one target host, comprising;
a security-analysis tool in communication with the network;
a security workspace in communication with the network, further comprising a data store;
a plurality of workspace modules, further comprising:
a data intake and integration module configured to receive security information from the security analysis tool into the security workspace and enter the security information into a first column and a second column of a table in the data store;
a weight assignment module configured to add a third column to the table;
a partitioning module configured to determine a smallest-cost partition of a bipartite graph represented by the table; and
an electronic display configured to display the smallest-cost partition.

2. The system of claim 1, further comprising a relational database in the data store.

3. The system of claim 1, wherein the workspace is configured to host one or more of the plurality of workspace modules.

4. The system of claim 1, further comprising a graphing module configured to render the table as the weighted bipartite graph.

5. A computer based method for clustering security-related information in a network comprising security-analysis applications, at least one security workspace, a target system comprising at least one target host, comprising the steps of:
receiving information from a security analysis of a target system into a security workspace;
processing the security information into a first column and a second column of a table;
storing the table in the security workspace;
adding a third column to the table;
determining a smallest-cost partition of a bipartite graph represented by the table; and
displaying the smallest-cost partition.

6. The method of claim 5, wherein the third column comprises a first set of weight values.

7. The method of claim 6, wherein the weight values are entered manually by a user.

8. The method of claim 6, wherein the weight values all have the value 1.

9. The method of claim 6, further comprising the step of updating the third column with a second set of weight values.

10. The method of claim 5, further comprising the step of:
encoding security-related information from the workspace,
wherein the first column of the table represents a first information type of the security-related information, and the second column of the table represents a second information type of the security-related information.

11. The method of claim 10, wherein the first label type comprises a host label.

12. The method of claim 11, wherein the second label type represents a service label.

13. The method of claim 6, wherein determining the smallest-cost partition of the bipartite graph further comprises the step of constructing the partition by minimizing a normalized sum of edge weights between unmatched pairs of vertices of the bipartite graph.

14. The method of claim 5, further comprising the step of approximating a solution to determining the smallest-cost partition by computing a partial singular value decomposition (SVD) of an associated edge weight matrix of the bipartite graph.

15. The method of claim 6, wherein the second label type represent vulnerabilities given by their Common Vulnerabilities and Exposures (CVE) number and weight values are the associated Common Vulnerability Scoring System (CVSS) numbers.

16. A computer based security analysis method for clustering security-related information in a network comprising a security-analysis application, at least one security workspace, at least one target host, and a distance function for bipartite graphs, the method comprising the steps of:
receiving a piece of data by the security workspace from the security-analysis application, the data comprising at least a host label and a second label associated to this host;
creating a partition of the data;
associating the data with a weighted bipartite graph; and
finding a partition that minimizes a cost over all possible partitions.

17. The method of claim 16 wherein the hosts are labeled by their IP address, the second label comprises services that are labeled by port numbers.

18. The method of claim 16, further comprising the steps of:
storing a tree of partitions;
recursively examining if a stop condition is met for each partition that represents a terminal leaf of the tree; and
creating a partition of each bipartite graph represented by a terminal leaf where the stop condition is not met.

19. The method of claim 18, wherein the predetermined value has been established, and the stop condition is established by one of the group consisting of:
computing the number of hosts in each partition and establishing a stop if the number is below the predetermined value, and
establishing a stop if the number of clusters is bigger than the predetermined value.

20. The method of claim 16, wherein a constant N has been predefined as a configuration parameter, and the stop condition is one of the group consisting of:
the bipartite graph has exactly N hosts or less, and
a size of the bipartite graph, computed as the sum of weights for all of its edges does not exceed the constant N.
